(19) United States
(12) Patent Application Publication
(10) Pub. No.: US 2008/0041440 A1
(43) Pub. Date: Feb. 21, 2008

(54) Solar panel condenser

(76) Inventors: Daniel G. O'Connell, Wailuku, HI (US); Terry Born, Wailuku, HI (US)

Correspondence Address: MORGAN LEWIS & BOCKIUS LLP, 1111 PENNSYLVANIA AVENUE NW, WASHINGTON, DC, 20004, US

(21) Appl. No.: 11/512,418

(22) Filed: Aug. 30, 2006

Related U.S. Application Data
(60) Provisional application No. 60/837,918, filed on Aug. 16, 2006.

(51) Int. Cl. H02N 6/00

(52) U.S. Cl. 136/246

(57) ABSTRACT

The present invention relates to a solar panel condenser apparatus which includes an optical condenser and a photovoltaic cell mounted substantially parallel to the optical condenser and placed about midway between the optical condenser and the focus of the optical condenser. The optical condenser can increase the effective area of the photovoltaic cell and increase the output power of existing photovoltaic cells by a factor of from about 2 to 4.

### RELATED APPLICATION

This application claims priority of copending Provisional Application No. 60/837,918, filed on Aug. 16, 2006.

### INCORPORATION-BY-REFERENCE OF MATERIAL SUBMITTED ON A COMPACT DISC

Not applicable.

### SEQUENCE LISTING

Not applicable.

### BACKGROUND OF THE INVENTION

1. Field of the Invention

The present invention relates generally to the field of photovoltaics, and more specifically to an apparatus for increasing the power output of photovoltaic cells.

2. Description of Related Art

A solar cell is a semiconductor device that converts incident photons from the sun (solar radiation) into useable electrical power. The general term for a solar cell is a Photo-Voltaic (PV) cell. The output of a conventional PV solar cell is limited to approximately 10% efficiency and as much as 15% in high end single crystal silicon solar panels. Single crystal silicon PV cells have a higher efficiency than polycrystalline silicon; however, they are considerably more expensive.

A traditional PV cell consists of a single layer p-n junction made of single crystal silicon. Lower cost poly-crystal silicon material is now being used in these traditional PV cells, but at the cost of lower efficiency. Incident photons cause the photoelectric effect by raising electrons into a region in the material known as the conduction band where the electrons are free to flow as current. When the material is connected with an external circuit, the photo-generated current can be utilized as electrical power.

A new generation of solar cells uses multiple layers of p-n junction diodes, each layer designed to absorb a successively longer wavelength (lower energy) photon of light energy that penetrates deeper into the material, thus absorbing more of the solar spectrum and increasing the amount of electrical energy produced. Such new generation PV cells can have efficiencies of around 20%, with efficiencies of as much as 30% being demonstrated in research laboratories. These research projects use very expensive multiple layer PV material that may not reach the consumer for many years to come.

The low efficiency (10-20%) that exists in PV solar cell technology is attributed to a narrow spectral range of solar radiation (FIG. 1) incident on the solar cell that is absorbed, thus resulting in usable electric current. The host crystal is doped with two specific materials, one having an excess outer valence electron (n-material) and the other lacking an outer valence electron (p-material). The boundary between the doped layers forms the p-n junction that establishes an electrical barrier or energy bandgap. As described in equation 1, electrons in the n-material must be excited with sufficient energy by an incident photon to cross the bandgap and enter the conduction band, which effectively sweeps free electrons away as useable current.

E_{g}≦hv Equation 1

(Where E is the energy in a photon of frequency v, and h is Plank's constant)

Long wavelengths in the near infrared and infrared range are outside the usable spectral range because they are transmitted through the material or deep into the material beyond the desired absorption layer. Shorter wavelengths in the ultraviolet and blue range are more readily absorbed by the semi-conductor; as a result higher energy photons do not reach the desired n-doped absorption region. Therefore, only a limited spectral band of incident solar radiation is used by existing photo-voltaic solar cells.

Typical PV material used as a solar cell for power generation is used in a forward bias configuration. As described in Equation 2, the photo-generated current (i_{g}) is linearly proportional to the number of incident photons over a large range.

i_{g}=ηqA_{d}E_{q} Equation 2

E_{q}—photon irradiance in photons per second per square meter.

η—quantum efficiency of the material

q—charge on an electron

A_{d}—area of the detector or solar cell

A certain number of electrons that are generated do not contribute to useable current. These noise electrons (or, in terms of current, noise current) limit the output of a solar panel. Some of the noise current is generated when the material operates at elevated temperatures, such as would occur in hot climates.

Attempts, such as those discussed above, have been made to improve the output of PV cells. However, these modifications to PV material and PV cell configuration have resulted in only modest improvements in PV cell output, at least with respect to that of the traditional PV cell.

U.S. Pat. No. 4,892,593 is directed to a solar energy collector which includes, among other features, a light funneling trough containing a pair of light reflecting surfaces extending from an apex line in an oblique angle, a two dimensional Fresnel lens, and a photovoltaic panel facing the Fresnel lens. Given its complex mechanical configuration, the solar energy collector is relatively expensive to manufacture, and the collector is not mounted in close proximity to the PV panel.

U.S. Pat. No. 6,958,868 is directed to a solar collector for concentrating solar radiation consisting of a Fresnel lens and one or more arrays of prismatic cells. The light rays are directed to the focal point of the optic. As with U.S. Pat. No. 4,892,593, this solar collector is expensive and volumetrically inefficient.

Thus, there remains a need to improve the output of PV cells and do so in a cost and space efficient manner.

### SUMMARY

Accordingly, the present invention is directed to a solar panel condenser that substantially obviates one or more of the problems due to the limitations and disadvantages of the related art.

An object of the invention relates to a solar panel condenser apparatus comprising an optical condenser and a photovoltaic cell mounted substantially parallel to the optical condenser and placed about midway between the optical condenser and the focus of the optical condenser, wherein the separation distance between the optical condenser and the photovoltaic cell is less than about 12 inches and the surface area of the photovoltaic cell is less than that of the optical condenser.

In one embodiment, the optical condenser is substantially oriented in a single plane.

In other embodiments of the invention, the separation distance between the optical condenser and the photovoltaic cell is less than about 6 inches, preferably less than about 4 inches, and more preferably less than about 2 inches. Generally, in such embodiments, a shorter focal length condenser is used.

In other embodiments of the invention, the optical condenser increases the effective area of the solar cell by a factor of at least 2 and up to 4.

In yet other embodiments of the invention, the solar panel condenser apparatus further includes a tracking system that keeps the solar panel condenser apparatus facing the sun.

In another embodiment, the solar panel condenser apparatus comprises a plurality of optical condenser lenslets.

Additional features and advantages of the invention will be set forth in the description which follows, and will be apparent, in part, from the description, or may be learned by practice of the invention. The objectives and other advantages of the invention will be realized and attained by the structure particularly pointed out in the written description and claims hereof, as well as the appended drawings.

It is to be understood that both the foregoing general description and the following detailed description are exemplary and explanatory and are intended to provide further explanation of the invention as claimed.

### BRIEF DESCRIPTION OF THE DRAWINGS

The accompanying drawings, which are included to provide a further understanding of the invention and are incorporated in and constitute a part of this specification, illustrate embodiments of the invention and together with the description serve to explain the principles of the invention.

FIG. 1 is a graphical depiction of a measured solar spectrum and calculated blackbody radiation, based on a 6,000 degree Kelvin blackbody.

FIG. 2 is a general diagram of the solar panel condenser apparatus concept according to the invention.

FIG. 3 is a rear view of an embodiment of the solar panel condenser apparatus.

FIG. 4 is top view of an embodiment of the solar panel condenser apparatus.

FIG. 5 is a view of the solar panel condenser apparatus with a focal ratio (F/number) of F/0.5.

FIG. 6 is a view of the solar panel condenser apparatus with an focal ratio of F/0.25.

FIG. 7 is a view of an embodiment of the solar array, wherein the separation distance between the optical condenser and the photovoltaic panel is about 3 inches and the focal ratio is F/1.

FIG. 8 is a view of an embodiment of the compact solar condenser with a 2 inch separation and a focal ratio of F/1.

FIG. 9 is a view of an embodiment of the invention, which is described as a solar tower.

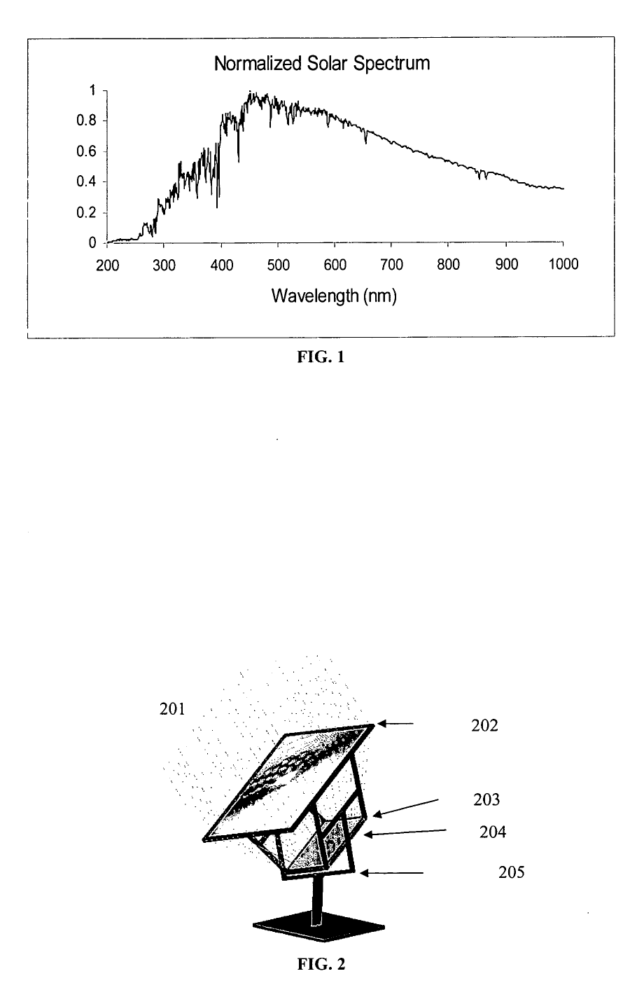

### DETAILED DESCRIPTION

Reference will now be made in detail to the preferred embodiments of the present invention, examples of which are illustrated in the accompanying drawings. FIG. 2 is an embodiment of the solar panel condenser apparatus that incorporates an optical condenser that is larger in collection aperture than the solar cell. The optical condenser (or solar condenser optic) can increase the effective area of the solar cell by a factor of about 2, preferably about 3, or more preferably about 4 (or any practical magnification ratio), therefore increasing the number of photons contributing to photo-generated electrons or usable current.

Solar energy does not generate sufficient current in typical solar cells to raise the material into saturation condition. Accordingly, use of a larger collecting optic can result in increased current output. As is evident from Equation 2, the increase in current, which can result from using an optical condenser, is linear over a large range prior to saturation. This is because the current is linearly proportional the increased number of photon hits that result from use of the optical condenser. The increase number of photon hits occurs, in essence, through the increase in effective area of the photovoltaic cell panel. Increased irradiance on the solar cell material will also raise the temperature of the solar cell, which in turn increases the number of electrons in the photovoltaic material that do not contribute to usable current, thus contributing to noise. This thermal heating reduces the available electrons for output current.

In one embodiment of the invention, the solar panel condenser apparatus includes an optional cooling system or cold plate (See FIG. 2) that reduces the temperature of the PV material, thereby reducing electron noise and increasing usable current. FIG. 2, which depicts this embodiment, shows incident solar radiation 201 emanating through optical condenser 202 unto photovoltaic cell (or solar panel) 203. Cold plate, or cooling system, 204 is in contact with photovoltaic cell 203 and is used to transfer heat away from the photovoltaic cell to reduce the increased temperature effect stated above and thus minimize unwanted noise. Consequently, this increases operating efficiency. FIG. 2 also shows the presence of optional tracking base 205, which is discussed in more detail below.

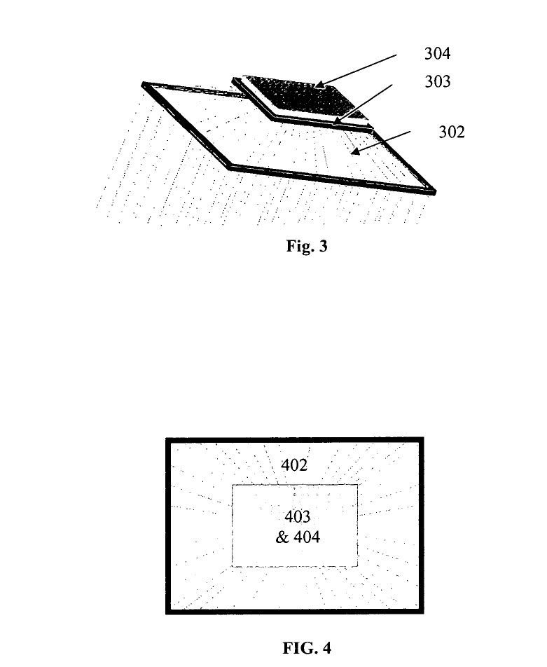

FIG. 3 provides a rear view of an embodiment of the solar panel condenser that includes cooling system 304 in addition to photovoltaic cell 303 and optical condenser 302. Cooling system 304 can include a heat sink, a cold plate or a cooling jacket, and can operate to minimize thermally generated charge carriers that are recombined with “holes” in the semi-conductor and thus do not contribute to current. As discussed, the larger effective collection area of the solar condenser has the tendency to raise the temperature of the PV substrate. The cooling system can therefore be used to lower the temperature of the PV substrate and thus minimize the adverse effect associated with this larger effective collection. Accordingly, use of a cooling system maximizes the benefit of the larger aperture condenser.

In another embodiment of the invention, the solar panel condenser apparatus comprises a solar tracking drive to allow the solar panel condenser apparatus to face the sun throughout the day and thus maintain maximum collection of incident solar energy. This embodiment can be seen in FIG. 2. A stationary solar panel only reaches maximum potential output at one point during the day. The collection area of a stationary panel is the cross-sectional area normal to the sun and follows a cosine function throughout the day. The effective collecting area of a stationary panel is reduced to 70% when the sun is at 45 degrees from its maximum elevation, 50% when the sun is at 60 degrees declination, reducing to a few percent during morning and evening hours. Thus, a tracking drive which can adjust the position of the solar panel condenser apparatus throughout the day can maintain the effective collecting area of a photovoltaic cell at or near maximum efficiency.

Since the optical condenser is not an imaging optic but rather a light collecting and condenser optic, it can be made with a very short focal length in order to minimize the separation between the solar condenser and solar cell to a few inches or less. The optical condenser can take the form of a Fresnel lens, a computer generated holographic optic, or any other refractive, reflective, diffractive or hybrid optical element. The primary goal of the condenser optic is to collect solar energy over a larger effective area than the area of the solar panel by condensing the light onto the PV solar cell. The solar condenser/magnifier can be machined, molded, pressed or etched into glass plastic or other optically transparent substrate.

Other Solar power generation systems utilize reflective mirror technology which requires a collection device to be located in front of the mirror, therefore obscuring usable solar energy. In these systems, the distance between the light collector and solar absorber can be significant, making it impractical for individual home use or roof top mounted systems.

The solar panel condenser invention integrates a conventional solar cell (of any type or manufacturer), a large aperture optical (or solar) condenser, which increases the effective collection surface area of the PV solar cell or panel, as well as an optional cooling jacket to reduce the temperature of the PV material and increase the output of usable electric current.

In other embodiments, the apparatus also incorporates an optional solar tracker (for certain applications) which keeps the system directed towards the sun, therefore maintaining maximum projected surface area.

The solar panel condenser innovation increases the light gathering of an existing solar panel and increases the current output by a factor of 2 (i.e., 200% increase in output) as demonstrated in a prototype system. Additional current gain can be achieved in an optimized system up to a potential limit of 4. An optical condenser that is 2 times larger on a side will have 4 times the collection area (See FIG. 4). Since PV solar cells typically do not operate in a saturated condition, the power output of a solar panel can be increased by increasing the collection area of existing solar panels. A larger optical condenser can be fabricated using inexpensive plastic material that is highly transmissive over a large wavelength range. The condenser material can be any optical material, not limited to glass or plastic. The condenser optic is designed to bend light rays that fall outside the area of the solar cell and redirect them to intercept the solar cell. Optical material such as glass or plastic used in transmission as a light collector or lens will suffer from approximately 5% light loss from reflections at each surface.

In an embodiment of the invention, the optical condenser utilizes broad-band anti-reflection coatings to reduce reflected light from the surface of the collector from approximately 5% to less than 1%. The optical condenser used in transmission configuration can take the form of a “Fresnel” lens, a modified Fresnel lens, or a general diffractive optic, or a hybrid refractive (or reflective) and diffractive optic. The solar panel condenser invention utilizes a very fast optic or very short focal length or low F/number. The optical condenser is not used as an imaging optic; therefore, very short focal lengths are possible in order to bring the optical condenser as close as possible to the solar cell itself. The optical condenser can thus be built directly into the solar panel framework, replacing the existing cover glass of a solar panel. In a preferred embodiment, the optical condenser is substantially oriented in a single plane. This facilitates building the optical condenser directly into the solar panel framework.

The photovoltaic cell is mounted substantially parallel to the optical condenser and placed about midway between the optical condenser and the focus of the optical condenser. The inventors have discovered that this feature unexpectedly offers several advantages. For example, locating the photovoltaic cell in this position reduces the spacing between the elements, thus resulting in a more compact arrangement. This location of the photovoltaic cell also substantially reduces the temperature of the photovoltaic cell material, thus resulting in a higher efficiency. If the material operated at elevated temperatures, as would occur if the photovoltaic cell were located closer to the focus of the optical condenser, excess noise electrons would be generated. Higher operating temperatures create thermally generated charge carriers that recombine within the photovoltaic cell material. This in turn creates noise current and reduces the amount of useable electrical power generated. Operating at increased temperatures also reduces the lifetime of the photovoltaic cell material. The elevated operating temperatures allow the material to become saturated, therefore not allowing all of the captured light to be converted into useable electrical power. Such saturation occurs when the concentrated photon flux reaches a certain level. Since the current output of a photovoltaic cell is linearly proportional to the number of incident photons over a certain operating range, when the incident photon flux reaches a certain level the material will saturate, thus preventing current from being produced with additional incident photons.

Additionally, locating the photovoltaic cell about midway between the optical condenser and its focus allows the user to rely upon only a single lens element as opposed to using additional optical elements which would be necessary in systems where the solar cell is placed at or near the focus. Accordingly, locating the photovoltaic cell about midway between the optical condenser and its focus requires less optics, thus reducing volume, complexity and cost.

The unique location of the photovoltaic cell in the embodiments of the present invention also allows for the use of lower quality lenses, which results in a cost savings. Locating the photovoltaic cell about midway between the optical condenser and its focus results in a more uniform distribution of the light rays. Aberrations exist in a single element Fresnel lens which produce non-uniform energy distribution at or near the focus, including, for example, a spherical aberration or a chromatic aberration. Such aberrations are optical effects that spread light rays, redistributing energy as they approach the focus of a lens. This redistribution of energy creates regions of increased energy and other regions of reduced energy, thereby creating hot spots in a photovoltaic cell substrate. By placing the photovoltaic cell midway from the focus, the aberrations do not have the full impact on the light rays. Therefore, the distribution of light energy on the PV cell is more uniform, resulting in greater efficiency and performance. Accordingly, lower quality Fresnel lenses can be used. The use of lower quality lenses reduces lens cost and allows for the use of a focal length or F-number in a Fresnel lens of less than F/1, and potentially as low as F/0.5. This is due to the fact that aberrations in the photovoltaic cell arrangement of the present invention do not affect the distribution of energy as much as would occur with a system in which the photovoltaic cell is located at or near the focus. Uniformity of illumination enhances the performance, resulting in optimal operating conditions and therefore maximum efficiency. This further reduces the spacing between the condenser lens and photovoltaic cell, resulting in an extremely compact system.

Furthermore, the extra energy generated by locating the photovoltaic cell about midway between the optical condenser and its focus allows the user the option of sending the surplus energy to a power grid (potentially generating extra income for the owner) or redirecting the energy to a backup storage device, such as a battery or a capacitor, for later use.

The longer the focal length of a lens, the larger the magnification of an image formed by the lens. Similarly, the angular extent of an image is magnified for a longer focal length lens, which increases the sensitivity of alignment and rigidity required of a lens system. A longer focal length lens can be described as having a longer lever arm of the image formed by the lens. A given displacement of an object off-axis (or a misalignment of a lens) results in a greater lateral displacement of the image in the image plane. For a given focal length lens, the lever arm is greater in the focal plane than it is mid-way to focus due to the longer distance to the focal plane or near focal plane. Therefore, when the photovoltaic cell is not precisely aligned along the optical axis of the lens and/or the lens is not precisely orientated in the direction of the sun, lateral displacement of the concentrated energy at or near focus is magnified compared to a location midway from focus. Misalignment between the condenser lens and photovoltaic cell displaces the solar energy footprint off-axis to the condenser lens, resulting in an energy footprint that partially or completely falls off the photovoltaic cell. A photovoltaic cell located at or near focus thus suffers from high sensitivity to alignment and tracking. Therefore, a longer lever arm will displace the concentrated solar energy on the photovoltaic cell such that a very rigid structure to support the system and precise tracking is required, leading to a bulkier system that is heavier, more complex and more expensive. Therefore, a longer lever arm configuration (where longer lever arm refers to a photovoltaic cell located at or near focus as opposed to midway to focus) will suffer greatly reduced power generation and power fluctuations due to flexure, wind bounce, vibration, and non-ideal solar tracking.

By locating the photovoltaic cell at or near the mid point between focus, the electrical power output is less sensitive to structural bending or sagging, or misalignments that may be introduced during assembly or develop over time. Therefore, a system that utilizes a photovoltaic cell located midway from focus can be constructed from less expensive materials and be less rigid, bulky and heavy as a system where the photovoltaic cell is located at or near focus. Also, due to the previously described greater uniformity of illumination, shorter focal length condenser lenses can be utilized, thereby reducing the lens to photovoltaic cell spacing even further. A shorter focal length condenser lens enables the photovoltaic cell to be located in close proximity to the condenser lens or lenslet array.

For solar tracking applications, the solar tracking device is not required to be as precise, thus allowing the user to use a low-cost tracking system or even a non-tracking system, such as is commonly employed with stand-alone photovoltaic panels. A non-tracking system does not follow the sun and therefore does not benefit from maximum collection efficiently throughout the day. Many of today's solar panel systems do not track the sun, however, and are still useful in a wide range of applications. By locating the photovoltaic cell midway from the focus, non-tracking is possible for certain applications. However, by locating the photovoltaic cell at or near the focus, tracking is certainly required; otherwise the concentrated solar energy would be completely displaced off the photovoltaic cell for the majority of the day. Accordingly, in the embodiments of the invention, non-tracking or lower precision tracking can be implemented, thus resulting in a lower cost platform. The lateral displacement of concentrated solar energy is not offset much by imperfect solar tracking, which is not the case when the photovoltaic cell is located at or near the focus, where the entire energy footprint can be displaced off the photovoltaic cell with moderate wind loading on the structure, vibrations or imperfect solar tracking.

When the photovoltaic cell is located at or near the focus, the spacing between the condenser lens and solar cell is larger, therefore requiring a larger and bulkier support frame. The larger support frame is required to be more rigid than a support frame for a mid-focus configuration. When the photovoltaic cell is located midway from focus, the spacing between the condenser lens and solar cell is minimized; therefore, the support frame will be more rigid, less bulky, lighter and less expensive.

In addition, the sensitivity to misalignments of the solar cell and condenser lens has little effect, resulting in a more robust system that produces higher power production levels that do not fluctuate. Thus, additional benefits to the solar panel condenser apparatus described herein include, but are not limited to, the following. An apparatus whereby the photovoltaic cell is located midway from focus results in an energy producing system that is lighter, more compact and more robust, and that will produce greater peak and average power levels. Additionally, such a system is lower in cost and less complex. It uses a lower operating temperature and therefore operates at a greater efficiency, with greater uniformity of illumination, and with little or no power fluctuations due to dynamic misalignments from wind loading or vibration. In such a system, there is minimal power loss from static optical misalignments which occur during assembly or are developed over time. Additionally, minimal power loss from non-ideal tracking system.

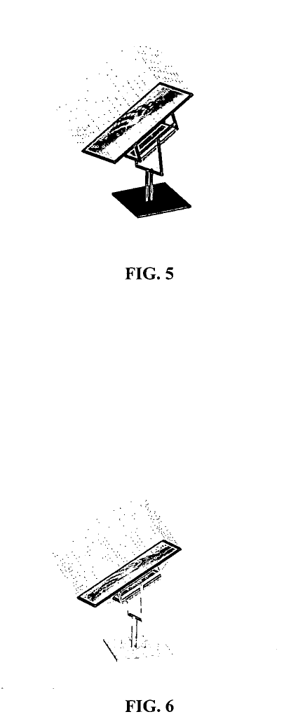

By reducing the separation distance between the condenser and solar cell to a few inches or less (see FIG. 5 and FIG. 6), it may be practical to use the solar condenser for very large area solar panel applications including, but not limited to, rooftop systems for home or industry use and eventually sub-stations. By making the optical condenser available in collapsible sections it can be used to increase the output of small portable solar panels by a factor of 2 or 3.

The optical condenser substrate can be made from inexpensive plastic (or glass). The optical focusing or light bending is achieved by forming structures on the surface of the condenser optic. The condenser optic is not limited to a Fresnel lens, but a modified Fresnel lens can be used with extreme focusing power where aberrations are not as detrimental as they would be in an imaging application.

The solar condenser invention includes fabrication methods for manufacturing the solar condenser optic. In order to make large area condenser optics, a mold is machined in metal or any other suitable mold substrate. The master mold contains arc structures that are sections of larger rings. Therefore, very large condenser optics can be fabricated without the requirement of a very expensive large mold for imprinting the surface refracting structures. Other methods of fabrication, include, but not limited to, laser or chemical etching, lithography, diamond turning, machining, stamping, pressing, embossing or any other replication techniques. The optical condenser can be made very large by fabricating sections of the optic rather than a continuous surface. Therefore, a condenser can be made in small sections and packed into a portable transport case. This will have tremendous benefit.

A lightweight lattice frame or other framework is constructed above the solar panel to hold a single solar condenser element or an array of smaller solar condenser sections making up a larger area. The solar condenser sections can be packaged in a portable carrying case for field use, to lower shipping costs or aid in installation. The solar condenser sections can be used to make a larger array for large area solar panel applications, including, but not limited to, complete rooftop systems.

The proximity of the solar condenser can be made small enough to build the condenser into the frame of the solar cell housing (FIG. 6). The framework supporting the condenser system can be carbon fiber or other lightweight material.

The solar condenser can be mounted in close proximity (about 2 to 4 inches) to the solar cell using very fast focusing condenser having a short focal length (FIG. 6). The solar cell is mounted mid-way or closer than the focal plane of the condenser optic. This allows the complete solar panel condenser apparatus (including optical condenser, solar panel, cold plate) to be mounted into a common frame.

In another embodiment, the optical condenser contains a dual purpose coating that (1) maximizes the transmission through the condenser optic over the wavelength range that contributes to photo-generated current as well as (2) blocks longer wavelength (or other) regions of the solar spectrum that do not contribute to useable current. The coating can be an important aspect of the condenser, as it can control the region of the solar spectrum that is incident on the solar cell. Photons outside the spectral response of the solar cell substrate contribute to heat and therefore loss of efficiency.

The broadband anti-reflection (AR) coating is optimized for the spectral response of the photo-voltaic substrate. A low-pass (LP) (cut-off or blocking filter) coating is designed in conjunction with the anti-reflection coating. The low-pass anti-reflection (LP-AR) coating will reduce reflection losses (from 5% to less than 1%) as well as block wavelengths that do not contribute to useable current and only contribute to heating the substrate material therefore reducing efficiency. The combined LP-AR coating can be optimized for other solar cell materials not limited to silicon based solar cells.

Unused wavelengths in the infrared for example will be blocked by the outer LP-AR coating on the solar condenser. Heating of the substrate is a large factor in reduced efficiency; therefore, the LP-AR coating in conjunction with the optional cold-plate (CP) will minimize efficiency losses due to heating and maximize the gain of the solar condenser. The benefit of this approach is that the current output of the solar cell remains a linear function (i.e., proportional to the number of incident photons) over a larger range prior to saturation. The LP-AR coating and CP enable the maximum number of photons captured by the large aperture solar condenser to be absorbed by the solar cell substrate resulting in useable photo-generated current.

The coating may also take the form of a bandpass coating that is specifically designed to match the spectral response curve of the solar cell substrate. In this configuration the bandpass coating has the highest transmission possible across the spectral bandwidth of the solar cell. The bandpass coating has band edges that are as steep as possible to provide maximum blocking of unwanted wavelengths outside the bandwidth of the solar cell. The bandpass coating blocks unusable photons that only contribute to heat and loss of efficiency and do not contribute to useable current. The bandpass coating is an alternative to an anti-reflection coating and a low-pass filter. Any other bandpass, blocking, low-pass or anti-reflection coating can be applied to the solar condenser optic.

Examples of coatings that can be used in this embodiment of the invention include coatings available from Newport Thin Film Laboratory, Chino, Calif.

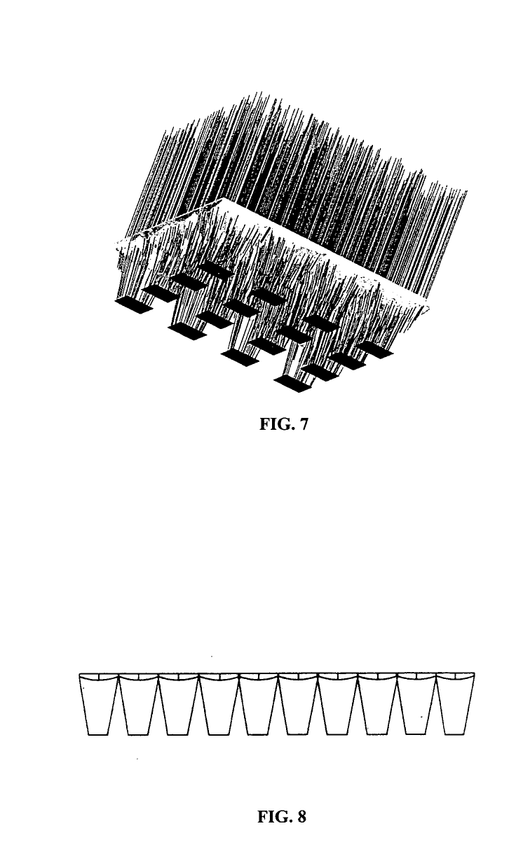

In another embodiment, the optical condenser comprises smaller aperture condenser lenses or lenslets (see FIG. 7). One benefit of this design is that a focal ratio of F/1 results in a much shorter focal length for a smaller aperture lens than for the full aperture condenser (F/number=focal length/aperture); therefore, the photovoltaic cells can be located much closer to the optical condenser, e.g., within a separation distance of about 3 inches or less, or within a separation distance of about 1 inch. This arrangement makes the solar condenser apparatus compact enough to be used for roof mounted and other systems.

The closer the photovoltaic cell can be placed with respect to the optical condenser, the less the sunlight distribution changes with sun angle. Larger focal ratios and larger separations between the optical condenser lens and photovoltaic cell result in the displacement of the solar irradiance mapped onto the photovoltaic cell throughout the day. Therefore, low F/number and close proximity are preferable to maximize the benefit of the solar condenser efficiency. Accordingly, a compact arrangement reduces the requirement of having a tracking system. A tracking system, however, remains an optional feature in order to keep the solar condenser apparatus pointed at the sun such that the projected collection area is maximized throughout the day.

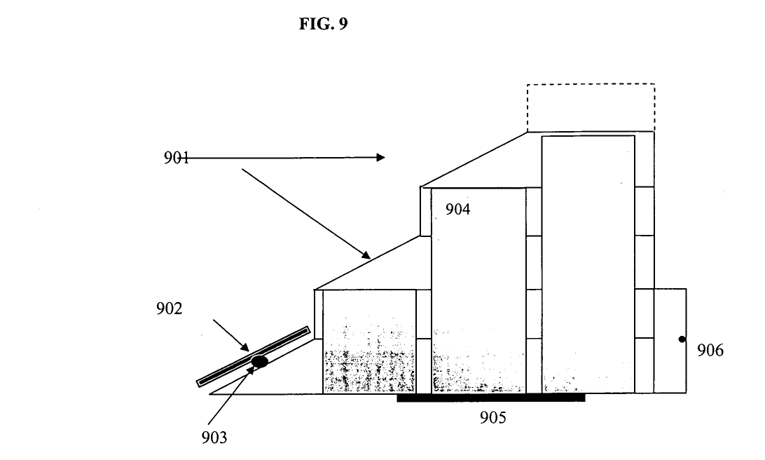

In this matrix configuration a two-dimensional array of smaller photo-voltaic solar cell elements (PV-Cells) are utilized instead of a large continuous solar cell panel (see FIG. 8). For a 1-meter by 1-meter optical condenser lens and a 0.5-meter by 0.5-meter photo cell area, the solar-cell can be made in smaller sections and be mounted in an array where each condenser lenslet is located above a PV-Cell. Here, the F/number of the solar condenser lenslet elements is not required to be as low as F/0.25 in order to achieve 3-inch or less separation (as is the case for the large aperture solar condenser), therefore simplifying manufacturing. Using the solar condenser technology as a single aperture light collector or collector array, the effective light collection area of the 0.5-meter by 0.5-meter solar cell is equivalent to the 1-meter by 1-meter light collector, therefore increasing the output of the solar cell by a factor of 4 (FIG. 9).

The solar condenser array can be made in small aperture lenslets ranging in size from, but not limited to, 25 millimeters up to 1 meter. Accordingly, manufacturing, assembly, shipping and installation costs are greatly reduced. The solar condenser array can be scaled to any practical size (many meters in size) using a two-dimensional array of PV-Cells and optical condenser lenslets. The amount of useable electrical power generated is increased by a factor of 2, 3, 4 or potentially more (depending on the ratio of solar collector to solar cell area, focal ratio and spacing) compared to an equivalent sized solar panel without the solar condenser technology.

The solar condenser array can be made very compact and produce four times more electrical current than an equivalently size solar panel. In addition, the condenser array in its compact arrangement eliminates the need to track the sun. However, an optional tracking system is part of the solar condenser technology for applications where tracking is beneficial. A tracking device maintains maximum effective collection area throughout the day. In addition a cooling plate further increases the efficiency of power conversion from incident photons into useable electric current.

In another embodiment, which can be seen in FIG. 9, the solar condenser and solar cell systems 902 can be mounted vertically to a tower structure to increase the collection area in a smaller footprint on the ground. The tower structure comprises staggered shelves 901 (similar to a layer cake) where each shelf further comprises solar cells tilted at an angle to maximize collection area. For larger power stations where a number of solar towers are required, each solar tower structure would be arranged geometrically to minimize shadowing from neighbor towers from sunrise to sunset. Each vertical tower can be rotated about its base 905 to maintain optimum angle of incidence between the sun and the solar cell. Each solar condenser and panel can also be mounted, optionally, on a pivoting base 903.

The inside of each solar tower comprises energy storage banks 904 such that required power can be supplied throughout the night, cloudy or rainy weather conditions. Banks of capacitors, batteries or other storage devices are arranged within the solar tower. Electrical power can be drawn from super capacitors by high-speed switching circuits that draw electrical current from the super capacitor banks without discharging them completely. Capacitors avoid additional energy conversion that takes place within batteries. Electrons that are generated by the solar cell are stored in the super-capacitor bank and drawn away as usable electrical current by power distribution circuitry. Batteries exhibit longer storage lifetimes without self-discharging over capacitors or super capacitors; however, super capacitors have longer lifetimes and are less environmentally hazardous. Capacitors by nature can be discharged in a few seconds, therefore switching circuitry and regulating circuitry draw current from capacitors in a controlled fashion without completely discharging them. Banks of capacitors, super capacitors, batteries or combination thereof are used to maintain constant supply of power as needed during times of reduced available solar energy. The energy storage bank is charged using excess electrical current available during times of peak solar electricity generation.

The energy storage reservoir within the solar tower consists of any combination of the following: batteries, super-capacitors, fluid or mechanical storage (described in Solar Electric Generator patent application).

The self-contained solar energy tower includes solar collection optics and solar cells mounted to shelves on the exterior of the tower for generating electrical power and a large chamber within the tower consisting of electrical storage units. Access to the chamber can be gained via an access door 906.

For rooftop mounted solar condenser and solar cell units, the energy storage reservoir may consist of an energy storage closet or shed that can be installed in the yard, within a garage or basement.

Lastly, the solar condenser can be used in conjunction with the “Thinned Solar Cell,” an invention of the same inventors, which is disclosed in a provisional application filed concurrently with this application. The Thinned Solar Cell invention increases the inherent efficiency of photo-voltaic solar cells to a potential 90% peak from the existing 25%. By combining the Thinned Solar Cell with the solar panel condenser apparatus, the electrical output, for a given area of solar cell material, can be increased by a factor of 12.

### EXAMPLES

### Example 1

A prototype design was constructed utilizing an F/0.25 effective focal ratio condenser optic, resulting in a 100 mm gap between the optical condenser and photovoltaic cell. This separation may be reduced with further optimization. The photovoltaic cell is placed midway between the optical condenser and the focus of the collector. The optical condenser therefore condenses a large percentage (˜97%) of incident photons over the area of the condenser such that they fall within the area of the solar cell.

The length of the optical condenser is made to be twice that of the photovoltaic cell and therefore has a collection area four times larger than the photovoltaic cell. The faster the condenser optic, or the shorter the focal length, the closer the photovoltaic cell can be placed with respect to the collector optic. A prototype apparatus was made using an approximately 36-inch×21-inch optical condenser and an approximately 18-inch×11-inch photovoltaic cell. Under non-optimal conditions, the output current of the prototype was increased by a factor of two. Therefore, the output of the highest efficiency photovoltaic panel can be doubled and potentially tripled when integrated with the optical condenser and cooling backplane.

As the present invention may be embodied in several forms without departing from the spirit or essential characteristics thereof, it should also be understood that the above-described embodiments are not limited by any of the details of the foregoing description, unless otherwise specified, but rather should be construed broadly within its spirit and scope as defined in the appended claims, and therefore all changes and modifications that fall within the metes and bounds of the claims, or equivalence of such metes and bounds are therefore intended to be embraced by the appended claims.

1. A solar panel condenser apparatus comprising:
(a) an optical condenser and
(b) a photovoltaic cell mounted substantially parallel to the optical condenser and placed about midway between the optical condenser and the focus of the optical condenser,
wherein the separation distance between the optical condenser and the photovoltaic cell is less than about 12 inches and the surface area of the photovoltaic cell is less than that of the optical condenser.

2. The solar panel condenser apparatus of claim 1, wherein the optical condenser is substantially oriented in a single plane.

3. The solar panel condenser apparatus of claim 1, wherein the optical condenser increases the effective area of the photovoltaic cell by a factor of at least 2.

4. The solar panel condenser apparatus of claim 1, wherein the optical condenser increases the effective area of the photovoltaic cell by a factor of at least 3.

5. The solar panel condenser apparatus of claim 2, wherein the optical condenser increases the effective area of the photovoltaic cell by a factor of about 4.

6. The solar panel condenser apparatus of claim 1, wherein the optical condenser comprises a Fresnel lens.

7. The solar panel condenser apparatus of claim 1, wherein the optical condenser comprises a holographic optic.

8. The solar panel condenser apparatus of claim 1, wherein the optical condenser is made of plastic.

9. The solar panel condenser apparatus of claim 1, wherein the optical condenser is made of glass.

10. The solar panel condenser apparatus of claim 1, wherein the optical condenser is made in sections.

11. The solar panel condenser apparatus of claim 1, wherein the separation distance between the optical condenser and the photovoltaic cell is less than about 6 inches.

12. The solar panel condenser apparatus of claim 11, wherein the separation distance between the optical condenser and the photovoltaic cell is less than about 4 inches.

13. The solar panel condenser apparatus of claim 12, wherein the separation distance between the optical condenser and the photovoltaic cell is less than about 2 inches.

14. The solar panel condenser apparatus of claim 1, further comprising a cooling plate in physical contact with the photovoltaic cell and located such that it is not between the photovoltaic cell and the optical condenser.

15. The solar panel condenser apparatus of claim 14, wherein the cooling plate comprises a Peltier cooling device.

16. The solar panel condenser apparatus of claim 1, further comprising a tracker backplane.

17. The solar panel condenser apparatus of claim 1, wherein the optical condenser comprises a coating that increases the transmission of light through the condenser optic over the wavelength range that contributes to photo-generated current and blocks longer wavelengths of the solar spectrum that do not contribute to usable current.

18. The solar panel condenser apparatus of claim 1, wherein the optical condenser comprises a plurality of condenser lenslets.

19. The solar panel condenser apparatus of claim 18, wherein the focal ratio of each lenslet is about F/1.

20. The solar panel condenser apparatus of claim 19, wherein the separation distance between the optical condenser and the photovoltaic cell is less than about 3 inches.

21. The solar panel condenser apparatus of claim 20, wherein the separation distance between the optical condenser and the photovoltaic cell is less than about 1 inch.

22. The solar panel condenser apparatus of claim 20, wherein each lenslet has a diameter of from about 25 mm to about 1 meter.

23. The solar panel condenser of claim 18, further comprising a cooling plate in physical contact with the photovoltaic cell and located such that it is not between the photovoltaic cell and the optical condenser.

24. The solar panel condenser of claim 23, further comprising a solar tracker.

25. An energy supply tower structure comprising
(i) a plurality of the solar panel condenser apparatuses of claim 2 tilted at an angle to maximize the solar collection area, wherein the solar panel condensers are mounted to vertical towers which are staggered in height and
(ii) energy storage banks located inside each vertical tower from which electricity can be drawn during periods of low solar energy production.

26. The energy supply tower structure of claim 25, wherein the vertical towers are rotatable about their base.

27. The energy supply tower structure of claim 25, wherein the energy storage banks are selected from the group consisting of capacitors, super capacitors and batteries.
